(19) United States
(12) Patent Application Publication
(10) Pub. No.: US 2012/0268711 A1
(43) Pub. Date: Oct. 25, 2012

(54) ASSISTIVE DEVICE FOR AIDING VISION CORRECTION AND REHABILITATION

(76) Inventor: Dar-Chung LAI, Taoyuan Hsien (TW)

(21) Appl. No.: 13/090,557

(22) Filed: Apr. 20, 2011

(51) Int. Cl. G02C 7/04

(52) U.S. Cl. 351/159.15; 351/159.18

(57) ABSTRACT

An assistive device for aiding vision correction and rehabilitation is disclosed, which comprises a body, and a vision accommodation aiding element formed with the body. The assistive device is formed as a biofeedback corrective contact lens that can modify the curvature of the cornea to aid correcting vision accommodation. The assistive device can be used in combination eye blinking effects to modify the length of the eye axis. Vision correction and biofeedback accommodation can be therefore achieved.

### BACKGROUND OF THE INVENTION

1. Field of the Invention

The present invention generally relates to an assistive device for aiding the correction of vision accommodation without using optical refractive correction.

2. The Prior Arts

Myopia increasingly affects larger population with the widespread use of display screens. Most commonly, myopia can corrected through the use of corrective lenses, such as glasses or contact lenses. More sophisticated techniques may use surgical remodeling of remodeling the cornea. These surgical techniques can include the use of excimer laser to ablate a portion of the cornea, or corneal incision procedures. However, all of the above techniques are aimed to correct the refractive defect through external intervention, and neglect the eye ability of self restoration and rehabilitation.

FIGS. 1A˜1F are schematic views showing conventional vision correction methods. In FIGS. 1A˜1B, a prolonged optical axis collimating method is shown, which uses an optical lens 11 (contact lens 12 or glasses 13) placed in front of the cornea 21 to modify the light refraction angle passing through the eye ball 2, so that image can be correctly formed on the retina 22.

FIG. 1C illustrates a surgical method using a laser beam La to ablate a portion of the cornea so as to modify the curvature of the cornea. Light can then refract correctly through the cornea to form a clear image on the retina.

FIG. 1D illustrates a corrective technique that uses a hard contact lens to remodel the shape of the cornea. The hard contact lens can have a top inner curve 122 that can remodel and flatten the curvature of the cornea 21.

FIG. 1E illustrates a surgical corrective method that places an annular implant 123 in the cornea. The implant 123 is made of an elastic material that can apply a stretching action to flatten the cornea 21.

FIG. 1F illustrates another alternative therapy that prescribes using eye exercises and relaxation to restore normal vision accommodation. In alternate methods, a drug can be used to relax the ciliary muscle 231 and dilate the pupil for restoring vision. In other methods, massage, electrotherapeutics or acupuncture may also be used to relax the eye muscle 232 for restoring vision accommodative functions. All of these methods constitute low-level biofeedback correction that may have limited results.

Accordingly, while the conventional optical refractive lens can correct the position at which light focuses without normal far vision accommodative function, long-term dependence may alter far vision ability and cause loss of chances of recovery. In worse case scenarios, the refractive defect may even worsen. On the other hand, surgical methods using laser ablation or corrective implants may have risks of post-operation sequalae, while cornea remodeling techniques may damage the cornea surface, and have risks of infection and ulcers. In addition, the above three methods can only correct the refractive defect of the cornea, and are unable to provide rehabilitation. Further, the use of drugs or mechanical action to relax the eye muscle, combined with eye exercises, can only provide limited results.

### SUMMARY OF THE INVENTION

A primary objective of the present invention is to provide an assistive device that can aid rehabilitation of eye accommodative functions for patients with amblyopia, strabismus, myopia, hyperopia and presbyopic symptoms.

In order to accomplish the above objective, the present invention uses a biofeedback corrective contact lens in combination with vision rehabilitation exercises that can involve biofeedback accommodative functions of higher brain levels.

According to one embodiment, the assistive device can comprise a body having a central region, and a vision accommodation aiding element formed in the central region, wherein the central region has a differential thickness configured to concentrate pressure applied on a cornea, thereby modifying a shape of the cornea and a length of an eye axis; wherein the assistive device is worn in front of an eye pupil for aiding vision accommodation during vision correction and rehabilitation.

According to one embodiment, the assistive device is formed as a biofeedback corrective contact lens having a predetermined refractive index, wherein the vision accommodation aiding element is formed as a window having a thickness and surface area that is able to change a curvature of the cornea, the surface area of the window covering the cornea defines a concentrated pressure region.

With the assistive device provided by the present invention, the curvature of the cornea can be modified to aid vision correction and relieve the stress induced by vision accommodation.

### BRIEF DESCRIPTION OF THE DRAWINGS

The present invention will be apparent to those skilled in the art by reading the following detailed description of preferred embodiments thereof, with reference to the attached drawings, in which:

FIGS. 1A˜1F are schematic views showing conventional vision correction methods; and

FIGS. 2A˜2J are schematic views showing an assistive device for aiding vision correction according to diverse embodiments of the present invention.

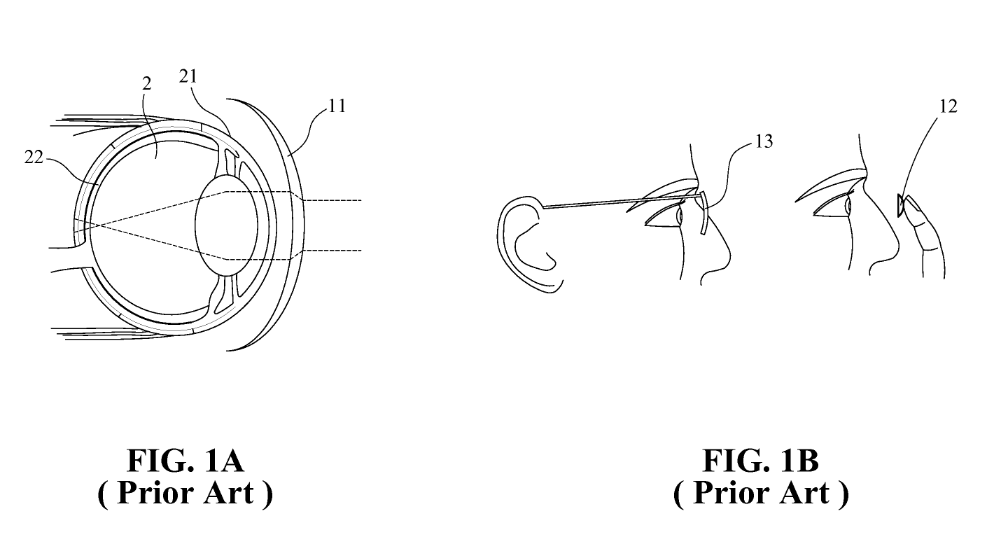

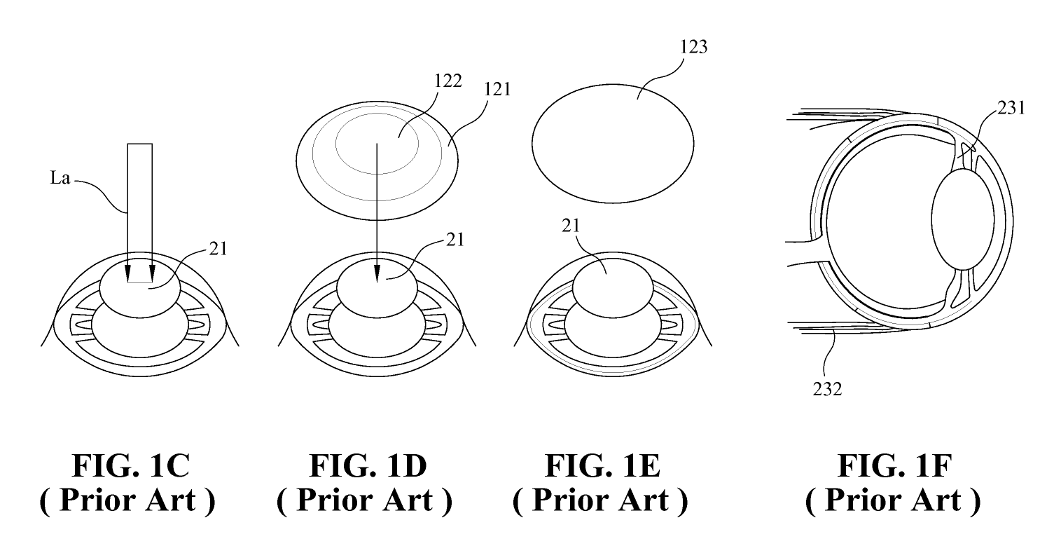

### DETAILED DESCRIPTION OF THE PREFERRED EMBODIMENTS

“Biofeedback correction” or “biofeedback corrective” as used herein means an active vision correction method using vision biofeedback accommodation, which differs from conventional optical correction techniques.

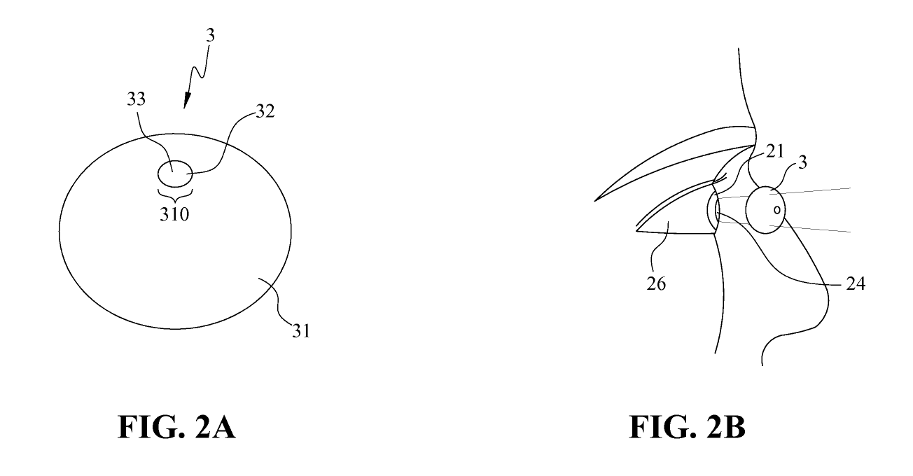

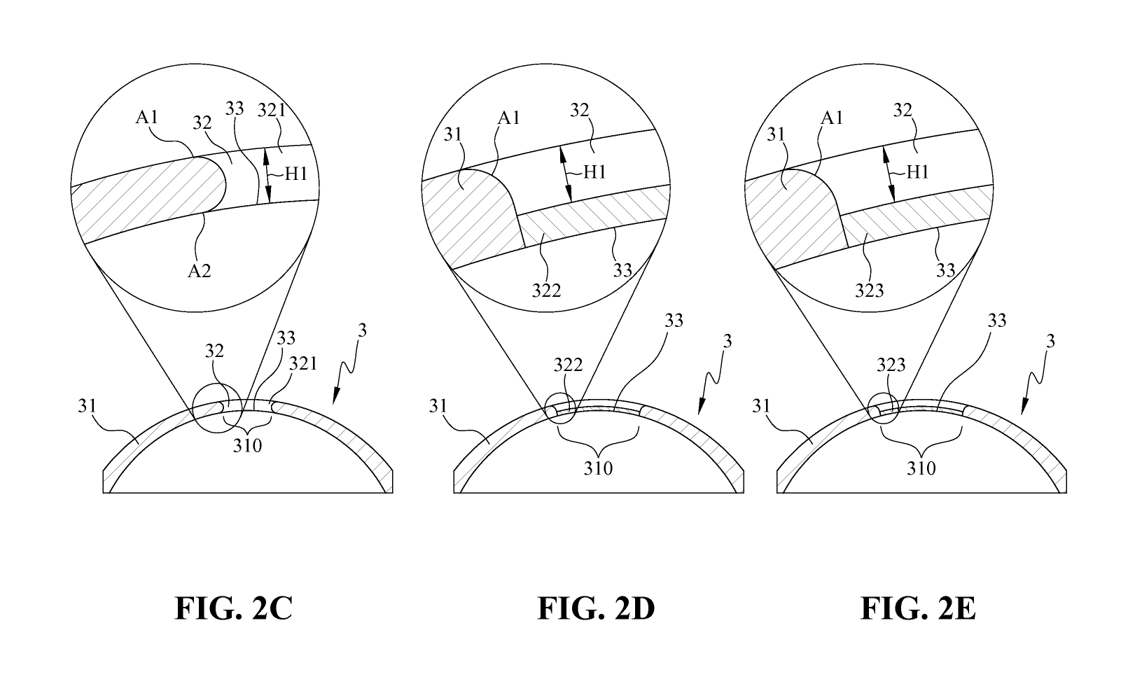

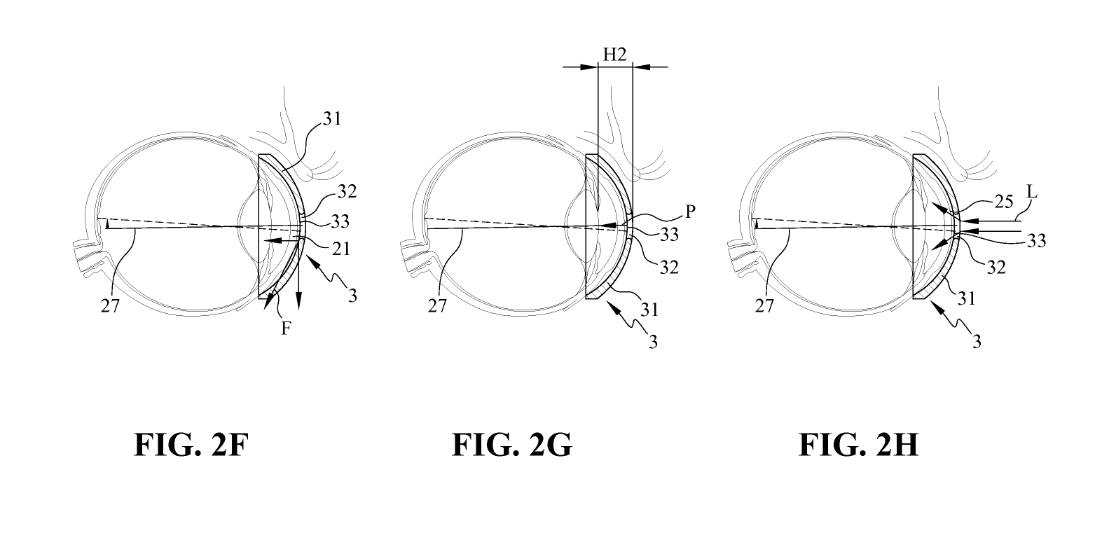

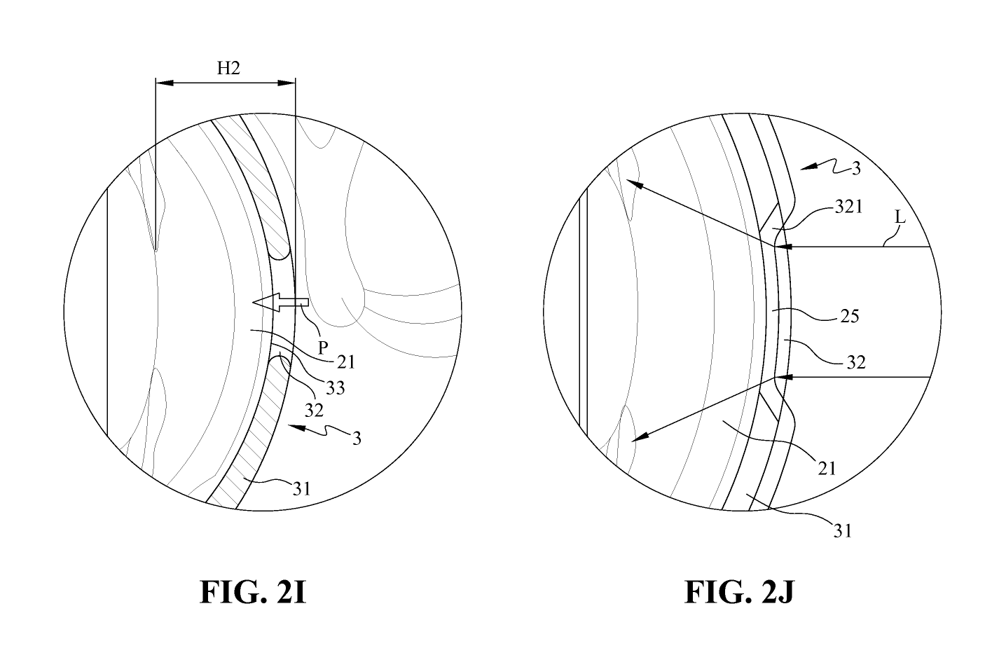

FIGS. 2A˜2E illustrate three different embodiments of a biofeedback corrective contact lens. The assistive device can be embodied as a biofeedback corrective contact lens 3 comprising a body 3 and a vision accommodation aiding element (window 32). The body 3 has a central region 310 in which is formed the window 32. The window 32 can be formed as a permeable aperture 321, a transparent film 322, or a target film 323 (as shown in FIGS. 2C, 2D and 2E). The window 32 can have a thickness and surface area that can act to modify the curvature of the cornea (thinner cornea will be subject to greater change). The window 32 is formed in the central region 310. The surface area of the window 32 that covers the cornea defines a concentrated pressure region 33. According to the design requirements, the window 32 can be a permeable aperture 321 (as shown in FIG. 2C), a transparent film 322 of a preset degree of transparency and refractive index that is laid at the aperture (as shown in FIG. 2D), or a target film 321 arranged at the aperture (as shown in FIG. 2E). In order to provide comfort of use, the central region can have edges forming rounding chamfers A1 and A2. The depth of the edges can form a refraction lens having a U-shaped groove for receiving a tear layer. This refraction lens is composed by tear liquid gathered at the region of the edge and window (shown as tear layer 25 in FIG. 2J). The body 31 and window 32 of the biofeedback corrective contact lens 3 can be made of a biologically compatible material. The structure of the central region can provide comfortable contact with the human's eye. The concentrated pressure region of the patient's cornea can be subject to stress applied by the structure of the contact lens as well as the pressure exerted by the blinking eyelid, which can act together to aid vision accommodation and rehabilitation.

Referring to FIG. 2D, the biofeedback corrective contact lens can be a soft or hard contact lens. The central region 310 of the biofeedback corrective contact lens 3 can have a circular profile similar to a conventional contact lens, such that it can be worn in a similar way. In use, the biofeedback corrective contact lens 3 can be placed on the eye at the front of the retina 24. With the body 31 covering the cornea 21, the window can self adjust to position itself above the retina. The diameter of the window (2 mm) is set to be smaller than the 7 mm average diameter of the retina 24 to take into account the change in curvature of the cornea owing to the action of the surface area of the window, such that it cannot slip outside the area of the retina. Moreover, the permeability of the window and the film type, edge thickness and other design parameters which affect the tension of the cornea 21 at the concentrated pressure region 33 can be modified as desired. It is noted that the contact lens can modify the state of the cornea through multiple ways, such as by adjusting the curvature of the base of the biofeedback corrective contact lens 3, its size, type of material, thickness, etc. However, the principal features described herein mainly use the type of window, its surface area, thickness, and the thickness of the central region. As shown in FIG. 2C, the permeable aperture 321 is formed in the body. The rounded chamfer A2 of the central region directly contacts with the cornea. As shown in FIG. 2D, the transparent film 322 has a preset degree of transparency and refractive index. The contact lens can have either no refractive index at all, or any refractive index. The refractive index can reduce the stress induced by vision accommodation. As shown in FIG. 2E, the target film 323 is smaller than the retina, and has a low degree of transparency. In particular, the target film 323 can have a near target for far vision, which can form an obstruction that forces the brain to use a wide field of view and expand the diameter of the retina for far vision. This constitutes a biofeedback accommodation that can compensate and reduce the low transparency obstruction of the target film to form a clear image.

Referring to FIGS. 2F-2H, the window 32 of the biofeedback corrective contact lens 3 can be formed as a permeable aperture, a transparent film, or a target film. The description hereafter exemplary refers to the embodiment of the permeable aperture. The difference in thickness at the rim of the window can modify the tension F (as shown in FIG. 2F) applied on the cornea 21 in the concentrated pressure region 33, the pressure P (as shown in FIG. 2G) applied by the blinking eyelid in the eye axis, and the refraction lens (as shown in FIG. 2H) formed by the tear layer 25 in the U-shaped groove. While the aforementioned three mechanisms have different functions, they all contribute to change the curvature of the cornea at the concentrated pressure region 33, which relieves the patient's pain induced by the accommodation of the refractive index. Moreover, clear vision can be recovered by self-accommodation. Accordingly, the concentrated pressure region 33 of the biofeedback corrective contact lens 3 can apply corrective and rehabilitation actions on the cornea 21, and promote vision accommodation.

FIGS. 2F and 2G, the change in curvature of the cornea 21 can be due to 1) the action of the contact lens structure (as shown in FIG. 2F), and 2) the pressure applied by the blinking eyelid (as shown in FIG. 2G), which are as detailed below:

(1) The body of the contact lens can be modified as the shape of the window changes to exert the stress F on the cornea. The structure of the window can be differently formed as a through hole or a thin film, which may apply the stress F to obtain different changes in the curvature of the cornea. Moreover, the difference in thickness of the central region can also act to generate the stress F. All of these features are associated with the structure of the contact lens.

(2) As the eyelid is blinking, the pressure applied on the cornea can also vary. When the eyelid is closing, a differential height (shown as height H2 in FIG. 2I) is formed between the eyelid and the cornea. The top of the cornea is therefore subjected to the highest pressure P applied by the eyelid, while another pressure P is applied on the cornea owing to the difference in thickness (shown as thickness H1 in FIGS. 2C, 2D and 2E) between the central region and the window (which may be a thin film or aperture).

Therefore, the pressure applied by the eyelid can be concentrated on the cornea at the concentrated pressure region 33 of the window 32. Each time the eyelid is blinking, the cornea 21 becomes relatively flatter, while the eyeball is compressed. As a result, the length of the eye axis 27 is shortened. While the above dimensional change is very slightly, it significantly corrects light refraction. According to the equation 0.375 mm=1 D between the length of the eye axis and the refractive index, the blinking movement of the eyelid can cause the length of the eye axis to shorten synchronously as the curvature of the cornea is deformed by the contact lens. As a result, the stress induced by vision accommodation can be relieved, which can improve vision accommodation and adaptation. Accordingly, eye blinking can importantly contribute to vision rehabilitation.

FIGS. 2E and 2I illustrate another way of modifying the refractive index of the cornea curvature with the biofeedback corrective contact lens. In this alternate embodiment, the U-shaped groove formed at the window is used to receive a tear layer (shown in FIG. 2E as tear layer 25 having a curved surface) that can be equivalent to a refraction lens capable of correcting and refracting image light striking on the eye (shown in FIG. 2E as arrow L representing parallel incoming rays that are then refracted through the tear layer 25). While this corrective effect is short, repetitive blinking of the eyelid can continuously change the configuration of the tear layer 25 in the concentrated pressure region 33, which can result in dynamic correction of the refractive index and vision accommodation for rehabilitation. This constitutes one way of aiding vision accommodation according to the present invention.

The designed structure and manufacture of the biofeedback corrective contact lens 3 can have an influence on the change in curvature of the cornea. Two examples are described hereafter for fabricating a biofeedback corrective contact lens by modifying the conventional soft contact lens.

### Specification Exemplar (not Limited to a Specific Material and Manufacturing Method)

In the present specification exemplar, the biofeedback corrective contact lens can be fabricated from a conventional soft, non-corrective contact lens by modifying the pupil area of the contact lens as follows:

(a) Materials

polymacon material containing 38.6% of water; refractive index: 0; diameter: 14.0 mm; curvature: 8.6 mm; and thickness at the center: 0.17 mm.

(b) Formation of the Window as an Aperture

thickness H1 of the central region: 0.13 mm; radius of the outer rounded chamfer A1 of the central region: 0.03 mm; radius of the inner rounded chamfer A2 of the central region: 0.03 mm; diameter of the aperture: 2 0 mm; and film thickness in the window: 0 mm (i.e., in case of the aperture) or 0.04 mm (i.e., transparent or target film).

### EXPERIMENTS

Experiments are conducted to verify that the structure of the biofeedback corrective contact lens, combined with the action of eye blinking pressure, can modify the curvature of the cornea and aid the patient's vision. In the experiment, the contact lens is worn 60 minutes and eye blinking pressure is measured synchronously. The testing method adopts a simplified external correction (i.e., insufficient correction index is measured after the biofeedback corrective contact lens is worn), whereby it is tested whether vision accommodation achieved through the biofeedback corrective contact lens can substitute for any optical refractive index. In a simpler way, the conducted test consists in determining whether the worn biofeedback corrective contact lens can aid vision accommodation, such that it can substitute for the corrected optical refractive index provided by typical corrective glasses. A test is conducted by wearing a −0 D biofeedback corrective contact lens (i.e., with no optical refractive index) and using an optical refractive test lens through which optometry is measured. In case the tested refractive index obtained with the external correction is smaller than the initial corrected refractive index, then it is verified that the patient's vision is effectively improved.

Accordingly, the experiments intend to test whether one function of the biofeedback corrective contact lens can aid vision accommodation, and also describe three other functions (i.e., isometropia, adjusted vision biofeedback, and isometropia biofeedback) as being within the range of the present invention.

Eye blinking plays an important role in aiding vision accommodation when wearing the biofeedback corrective lens. Indeed, the biofeedback corrective contact lens forms an additional cornea layer in which the window area (i.e., formed as an aperture or thin film) at the top is relatively thin. Each time the eye is blinking, this region is subject to the concentrated pressure exerted by the eyelid, and consequently forms a flattened curvature that shortens the eye axis. Accordingly, the vision aid function not only uses the contact lens to modify the curvature of the cornea, but also relies on the blinking movement of the eyelid to guide the change in curvature of the cornea and adjustment of the eye axial length. It is noted that the experiment should be timely controlled: the biofeedback corrective contact lens should be worn during a sufficient period of time (for example 60 minutes), and eye testing should be conducted promptly after the contact lens is removed (for example within 5 minutes after adaptation).

### (1) Aided Vision Accommodation

After the biofeedback corrective contact lens is worn, eye blinking causes flattening of the cornea curvature and results in the length of the eye axis to shorten, which can relieve the stress induced by vision accommodation.

### (2) Binocular Isometropia

The biofeedback corrective contact lens is placed on the right eye. While no biofeedback corrective contact lens is placed thereon, the left eye can see an image clearer than initially owing to binocular isometropia induced by the aided visual accommodation of the right eye.

### (3) Biofeedback of Vision Accommodation

After the vision accommodation aiding function is applied over a period of time (about 60 minutes), the biofeedback corrective contact lens is removed. The right eye can then “remember” the aided accommodative function within a biofeedback accommodation period of time, during which the cornea has not yet recovered its initial configuration. Brain plasticity rehabilitation can be thereby achieved through this aided vision accommodation applied on one eye.

### (4) Isometropia Biofeedback

After the foregoing binocular isometropia (about 60 minutes), the biofeedback corrective contact lenses are removed. The two eyes can then “remember” the aided accommodative function within a biofeedback accommodation period of time, during which the cornea has not yet recovered its initial configuration. Brain plasticity rehabilitation can be thereby achieved through this aided vision accommodation applied on the two eyes.

In one embodiment, experiments are conducted as described above in 1). The optometry conducted while the biofeedback corrective contact lens is worn is aimed to detect whether the patient is still subject to insufficient refractive index even with the biofeedback corrective contact lens. The experiment can be performed according to the following steps:

The experiment is aimed to test the effects of the lens and eye blinking on the change of the cornea. More specifically, three testing values must be within determined with a specific order:

Step 1/C (initial refraction corrected index) is the requisite first testing stage. Afterwards, the biofeedback corrective lens is worn 60 minutes, and eye blinking is exercised.

Step 2/A (vision accommodation through the biofeedback corrective lens) then tests the replaceable optical refraction corrective index. In case of light myopia, directly see clearly 20/20, if severe myopia then step 3/B has to be repeated to test the insufficient refractive index.

Step 3/B (External correction through the biofeedback corrective lens) tests the yet insufficient refractive index while the biofeedback corrective contact lens is worn. A test frame is worn, and test lenses −0.25 D are progressively worn until the vision with respect to a test table reaches a corrected refractive index of 20/20 (1.0).

The test equation for testing the external correction provided by the biofeedback corrective lens is defined as (A+B=C), wherein “A” represents the vision accommodation of the biofeedback corrective lens (i.e., the correction of the replaced refractive index); “B” represents the external correction of the biofeedback corrective lens (20/20 correction of the test lens); “C” represents the initial refraction corrected index (measured glass refractive index).

When A+B=C (A can have any aided vision accommodation), if the test result is A=C corresponding to light myopia (correction and vision testing do not require test lens), or B<C corresponding to severe myopia (correction and vision testing require test lens), then it is verified that A has the aided vision accommodation of the biofeedback corrective contact lens.

### EMBODIMENTS

The experiment is conducted on 30 individuals to determine whether the biofeedback corrective contact lens can aid vision accommodation. Other effects are not tested. The experiment has to be conducted according to the following steps to obtain correct results.

1. Correction and vision testing are first applied on bare eyesight/C=initial refraction corrective index. This may be performed by using computer testing or testing frames to obtain the corrected refractive index C.

2. The biofeedback corrective contact lens is worn for about 60 minutes. During this period of time, the occurrence of eye blinking constitutes the aided vision accommodation A.

3. External correction and vision testing are applied while the biofeedback corrective contact lens is worn/value B of 20/20 correction with test lenses. A+B=C is the equation that verifies the ability of aiding vision accommodation. If the test result is:
(1) light myopia A=C (no further correction and vision testing are required); or
(2) severe myopia B<C (further correction and vision testing are required);
(3) unless B=C, A=0, meaning that there is no ability of aided vision accommodation; otherwise, the obtained value A can successfully verify the ability of aided vision accommodation.

In the above experiment, patients with light myopia who do not need further correction and vision testing include 14 individuals (i.e., B=0 and A=C), and only one individual needs test lenses and vision testing to 20/20. Moreover, 15 individuals with severe myopia still need to wear test frames and undergo vision testing with progressive increasing steps of −0.25 D to 20/20 (only 2 individuals cannot reach 20/20 after correction and vision testing, i.e., B=C).

In the foregoing experiment applied on 30 individuals with myopia (15 individuals with light myopia, and 15 individuals with severe myopia), above 90% of tested individuals have a value A that verifies the ability of aided vision accommodation.

The above one-time experiment has 90% exhibiting this effect. When A+B=C, and B=0 or B<C, then the ability of aided vision accommodation is verified for the biofeedback corrective contact lens. Although less than 10% of tested individuals do not exhibit clear beneficial results, significant improvement can be observed after the biofeedback corrective contact lens is subsequently worn over a longer period of time (6 hours). Accordingly, it is demonstrated that the biofeedback corrective contact lens can effectively aid vision accommodation.

As described previously, a one-time experiment conducted during 60 minutes can verify that the biofeedback corrective contact lens effectively aids vision accommodation. The biofeedback corrective contact lens described herein can have a large range of application, and used in combination with rehabilitation techniques to improve the patient's vision.

The foregoing description is intended to only provide illustrative ways of implementing the present invention, and should not be construed as limitations to the scope of the present invention. While the foregoing is directed to embodiments of the present invention, other and further embodiments of the invention may thus be devised without departing from the basic scope thereof, and the scope thereof is determined by the claims that follow.

What is claimed is:

1. An assistive device adapted for vision correction and rehabilitation, comprising:
a body having a central region; and
a vision accommodation aiding element formed in the central region, wherein the central region has a differential thickness configured to concentrate pressure applied on a cornea, thereby modifying a shape of the cornea and a length of an eye axis; wherein the assistive device is worn in front of an eye pupil for aiding vision accommodation during vision correction and rehabilitation.

2. The assistive device as claimed in claim 1, being formed as a biofeedback corrective contact lens having a predetermined refractive index, wherein the vision accommodation aiding element is formed as a window having a thickness and surface area that is able to change a curvature of the cornea, the surface area of the window covering the cornea defines a concentrated pressure region.

3. The assistive device as claimed in claim 2, wherein a peripheral edge of the central region forms a rounded chamfer.

4. The assistive device as claimed in claim 2, wherein the peripheral edge of the central region has a thickness and shape that form U-shaped groove in which tear liquid is contained for forming a refractive lens.

5. The assistive device as claimed in claim 2, wherein the window is formed as an aperture through the body.

6. The assistive device as claimed in claim 2, wherein the window includes a transparent film having a predetermined degree of transparency and refractive index.

7. The assistive device as claimed in claim 2, wherein the window includes a target film smaller than the eye pupil, the target film forming a close target having a low degree of transparency for far vision.
